(19) United States
(12) Patent Application Publication
(10) Pub. No.: US 2005/0104855 A1
(43) Pub. Date: May 19, 2005

(54) Double side transparent keyboard for miniaturized electronic appliances

(75) Inventor: Mark Grossmeyer, Cedarburg, WI (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Paradigm Research Technologies LLC, Cedarburg, WI (US)

(21) Appl. No.: 10/717,835

(22) Filed: Nov. 19, 2003

(51) Int. Cl. G09G 5/00

(52) U.S. Cl. 345/169

(57) ABSTRACT

An optically or electronically transparent keyboard is disclosed having a key support, a display area, and keyboard transparency enabling keyboard operation from the front or rear. A keyboard, preferably of the QWERTY variety, is provided with transparent keyboard sections overlying one another. The keyboard sections when open dispose keyboard halves. QWERTY alignment is the same on the front and backside of the keyboard so that data entry is intuitive. Operation of the folding transparent keyboard can occur conventionally on a support surface or be enabled by support of the keyboard and miniaturized device in the palms of the user. In the palms of the user, the backside keyboard can be used with transparent viewing of the finger input. The sides of the keyboard are ergonomically shaped to position the hands properly, give better control of the keyboard while also making it easier to enter data.

### CROSS-REFERENCES TO RELATED APPLICATIONS

Not Applicable.

### STATEMENT AS TO RIGHTS TO INVENTIONS MADE UNDER FEDERALLY SPONSORED RESEARCH OR DEVELOPMENT

Not Applicable.

### REFERENCE TO A “SEQUENCE LISTING,” A TABLE, OR A COMPUTER PROGRAM LISTING APPENDIX SUBMITTED ON A COMPACT DISK

Not Applicable.

This invention relates to portable keyboards for use with electronic devices. More particularly, a transparent keyboard has input from either side of the keyboard. Keyboard transparency is optical or electronic either through the keyboard itself or through the device's display. This allows regular keyboard input from both sides of the keyboard that can be either connected to a miniaturized electronic device or for the keyboard to be an integral part of the device. The electronic devices can be personal digital assistants (PDAs), cellular telephones, TV remote controls, tablet PCs, laptops and the like.

### BACKGROUND OF THE INVENTION

Miniaturized electronic devices such a as personal digital assistants (PDAs), cellular telephones, TV remote controls, tablet PCs, laptops and the like have proliferated in both quantity and use. Virtually all such devices require alphanumeric input. Unfortunately, as the devices themselves have become miniaturized, the means for inputting to such devices have also become miniaturized, extraordinary inconvenience results.

The most widely used alphanumeric input device is QWERTY keyboard, the keyboard array common to most personal computers. It will be understood that this invention applies to such QWERTY keyboards and all other types of keyboards. This keyboard is fitted in size to the hands of the keyboard user. Miniaturization of any keyboard, especially the QWERTY keyboard is almost always a failure. Simply stated, the hands of the user remain unchanged in size. As the keyboard decreases in size, the difficulty of input through the keyboard correspondingly increases. The inputting of data slows. If the keyboard is small enough, pointed probes have to be used, relegating the input to the “hunt and peck” method.

Folding keyboards that expand the full-size keyboards for use with personal digital assistants are known. By way of example, Palm Inc. of Milpitas, Calif. sells a keyboard, which folds in four separate sections into a collapsible encased disposition for transport. The keyboard must be set up to be used and requires a support surface. When in the open supported position, the keyboard has a protruding bayonet type connection which supports a Palm PDA with its display canted towards the user. Regular keyboard input can easily occur. Unfortunately, this keyboard is device specific, requires a support surface upon which to operate, and is not capable of operation while user is either standing without a support surface or while moving.

So-called “thumb keyboards” are known. These keyboards are held in the hand between the fingers and contact with the thumbs to the keys is utilized to input data. Data input is “all thumbs.”

Further, cording keyboards are known. These keyboards require pressing more than one key in coded sequences for character entry. While the keyboards are compact and the input usable once the cords are learned, the cording keyboards are not accepted. Specifically, the difficulty of learning and remembering the cords has proved a substantial impediment to such keyboards.

Keyboards operable from the reverse or back side are known. Such keyboards enable a device to be held in the hands while alphanumeric input occurs. Examples of such devices can be found in Conway U.S. Pat. No. 5,410,333 and Ni U.S. Pat. No. 6,297,752.

In the Ni′ 752 disclosure, the keyboard halves hinge from behind a display to a position on either side and above the display, where the keyboard halves can be conventionally used in a supported format. Unfortunately, if the keyboard is to be used from the rear of the display, the folding of the keyboard rotates the keys outside of the conventional QWERTY relationship. Instead of the QWERTY keys being horizontally aligned, they are vertically aligned. This transition is intuitively very hard to accommodate. Additionally, this Ni patent presents the concept of having an image of the keyboard presented to the viewer. The image of the keys must be aligned with the keys on the back of the device to be of any help. However the users fingers and the relationship to the keys are hidden from the user. Without that feedback many errors are made and typing is slow. In addition, the image on the display is alternative; either the image has the application being used presented or an image of the keyboard. There is no combination of images disclosed. There is no representation of the users fingers in relation to the keys or indication that a key has been pressed. It also does not allow for the image of the keyboard to be sized or moved on the display.

In Conway '333, a folding keyboard with keys on the back is disclosed, but this invention does not anticipate being able to use the same device to enter data both as a conventional keyboard and a backside keyboard. The Conway '333 invention requires some type of support of the keyboard (a supporting clamp or a strap around the users neck) to keep it off of the support surface (desk). Also with this invention the relationship of the users fingers to the keys are hidden from the user. Without that feedback many errors are made and typing is slow, especially for the new user or the infrequent user. It also spatially changes the relationship of the QWERTY keyboard; keys are not used in the conventional alignment.

In what follows, I disclose a generic folding keyboard useful with virtually any modern miniaturized electronic appliance requiring alphanumeric input.

The problem to be solved is a method of quickly entering data into miniature electronic devices and to be able to do it on the go. As the devices have been getting smaller the entry is getting harder. Attempts have been made but have failed.

A long-standing problem in the keyboard industry is to be able to touch type on a portable keyboard. The portable keyboard must be one that is thin, light weight, and optimized for quick data entry.

It is known in the industry that the requirements to enter data quickly on a keyboard are:

a. The spacing of the keys needs to correctly space to fit the size of the human hand. The QWERTY keyboard is an example of the correct spacing and the one everyone is accustomed to. The standard QWERTY keyboard has keys in the QWERTY pattern and spaced 19 mm apart. Changes to that standard, slows the typist down.

b. The user needs to be able to feel where his fingers are, that is the particular key they are pressing.

c. The user must have feedback to know if the key has been activated.

d. There needs to be a large key activation area. Many portable keyboards have to be pressed in the center of the key to get activation.

e. The user must be able to see the key labels so they do not have to memorize which key is which.

Finally, with miniaturized devices, corresponding miniaturized displays result. When the display shrinks, the difficulty of reading the display compounds the difficulty of data entry.

The reader will realize that the discovery of the problem to be solved, as well as the problem solution, can constitute invention. Insofar is the prior art has failed to recognize a method of quick data entry generic keyboard that is light weight, portable, and can be used with or without a supporting surface, invention is claimed

### BRIEF SUMMARY OF THE INVENTION

An optically or electronically transparent keyboard is disclosed having a key support, a display area, and keyboard transparency enabling keyboard operation from the front or rear. A keyboard, preferably of the QWERTY variety, is provided with transparent keyboard sections overlying one another. The keyboard sections when open dispose keyboard halves. QWERTY alignment is the same on the front and backside of the keyboard so that data entry is intuitive. Operation of the folding transparent keyboard can occur conventionally on a support surface or be enabled by support of the keyboard and miniaturized device in the palms of the user. In the palms of the user, the backside keyboard can be used with transparent viewing of the finger input. The sides of the keyboard are ergonomically shaped to position the hands properly, give better control of the keyboard while also making it easier to enter data.

The optically transparent keyboard version allows viewing of the fingers through the keyboard itself, so the user gets visual feedback of the position of their fingers, relative to the keys, while typing on the backside of the keyboard. The electronically transparent keyboard uses a display, proximity sensors, an image of the keyboard and an indication the users fingers position, so the user gets visual feedback of the position of the users fingers, relative to the keys, while typing on the backside of the keyboard.

The electronically transparent keyboard constitutes a display surface for displaying both the application program and having a superimposed keyboard image. Typing on the backside of the keyboard produces telltale indications, of both finger proximity and data entry, on the touch sensative display.

To help the user have feedback where their fingers are in relationship to the keys, an image of the keyboard is displayed on the front of the device along with indication the position of their fingers. The fingers position are sensed by proximity sensors (Infrared, capacitance, cameras and the like) to indicate where the user's fingers are in relation to the keys. The fingers can be shown as a highlighting of the keys that the fingers are closest to or an image of the fingers can be shown.

A unique feature of this invention is that the keyboard image displayed on the screen can vary in its level of transparency in relationship to the application program be used. Both data and the application are visible at the same time to maximize the use of the screen real estate. The user can adjust the keyboard image for the level of transparency. For example, when first using the keyboard, the user may choose to display the key and finger placement more brightly. As the user gets better at typing with this method they can reduce the brightness of the displayed keyboard making the application stand out more.

Not only transparency, but also color and shading can be used to make the characters on the display visible without blocking the view of the application. One type of color change is the character would be displayed in reverse video. For example, if the application color is white, then the keyboard characters can be black. If the application color is black then the keyboard characters can be white. Crossing characters of both the keyboard and the program application can be distinguished. If the application's color changes in the middle of the keyboard character image, the intersecting characters can change in contrast so that both are distinguishable.

The position of the keyboard image on the screen can be sized and moved about the screen to place it in a position that allows the user the best viewing of the keyboard and application at the same time. For example, some applications do not take up the complete screen; therefore the user can move the keyboard image to another position on the screen so there is no overlapping of the application and keyboard image. Or they could display the keyboard image to fill the complete screen. Not only can the position on the screen be moved the image of the keyboard can be changed to another key layout. The QWERTY standard is the most familiar, but is not the only layout that is possible.

An exemplary electronic device can be a Tablet PC with a touch sensitive screen. This invention enables the keyboard to be on the front and backside of the Tablet PC. With the user holding the Tablet PC in between the palms of their hands they can type on the back and see the keyboard image on the Tablet PCs display. Typing on the front side of the Tablet PC can occur as the user presses on the image of the keyboard.

It is useful to control the keyboard operation so characters are not entered while the user is handling the keyboard or until they are ready to enter data. Accordingly, the keyboard not active until the user presses a special key or a combination of keys, such as the Function button and another key. Alternatively, if the user is using the backside keys, the keyboard is not active until the user has both hands in the correct position holding the keyboard at is respective sides, preferably at the disclosed indentations. To detect that the hands are in the correct position, there are sensors or switches on the sides, typically at the indentations.

The sides of the keyboard are shaped to fit the curvature of the hands. This shape helps the user to hold the keyboard so the keyboard and device does not drop while shifting hands (for example by the input of data). They also help to position the hands in the correct place for using the keyboard, especially for new users. Thirdly it allows the user to shift their hands around to each the harder to reach keys easily. With this shape there is less pressure needed by the palms to hold the keyboard. Instead the keyboard hangs from the hands. This is more comfortable and increases the data entry rate.

Still another feature of this invention is to have a pointing device that can be used without removing your hands from the backside keyboard. One method is for the user to use their thumb to move a pointer knob, which pointer knobs are found on many laptop computers.

Another feature of the keyboard is that is the keyboard not only can be built into a PDA, cell phone or other electronic devices, the PDA and cell phones can be quickly attached to the keyboard by a special double stick tape. This tape is reusable and when the stickiness is reduced the tape can be cleaned with water and the stickiness returns. This makes for a keyboard that can fit any model PDA, Cell Phone etc. A bracket that fits each device is not needed, and it can be removed just as fast as it is attached.

There are multiple methods of electronically connecting the keyboard to the device. One is the direct connect method. This is where a wire from the keyboard to the device is attached. A second is an I/R connection to the devices that have I/R port. A third method is short distance radio connections such as Blue Tooth (e.g.; which could connect a remote control keyboard to a TV.)

### BRIEF DESCRIPTION OF THE DRAWINGS

FIG. 1A is a perspective view of a bi-folded transparent keyboard having a central area for holding a connected miniaturized electronic device;

FIG. 1B is a perspective view of a bi-folded electronic keyboard having an integral electronic device and operable from the reverse side in accordance with the “electronically transparent operation” set forth hereafter;

FIG. 2A is a perspective view of an opened transparent tri-fold keyboard illustrating frontal use of the transparent keyboard with the supported miniaturized electronic device held in the portrait mode with the keyboard;

FIG. 2B is a perspective view of an opened transparent bi-fold keyboard illustrating frontal use of the transparent keyboard with an integral electronic device with the keyboard;

FIG. 3A is a perspective view of the opened transparent keyboard of FIG. 2A illustrating back side use of the transparent keyboard with sensors located at the keyboard end indentations actuating the keyboard for back side use with the supported to miniaturized electronically connected device held in the conventional vertical mode;

FIG. 3B is a perspective view of the opened transparent keyboard of FIG. 2B illustrating back side use of the electronically transparent keyboard with sensors located at the keyboard end indentations actuating the keyboard for back side use with the supported electronic device integral to the keyboard.

FIG. 4 is an electronic diagram of circuitry necessary for actuation of either the front side of the keyboard or the backside of the keyboard;

FIG. 5 is an electronic diagram of circuitry necessary for actuation of either the front side of the keyboard or the backside of the keyboard in combination with the superimposed image of the keyboard and the position of the fingers on the integrated keyboard display device.

FIG. 6A is an integrated keyboard-display-device with an superimposed image of the keyboard upon an application;

FIG. 6B is the same integrated keyboard-display-device as in FIG. 6A with a superimposed image of the keyboard upon an application program, the difference between

FIGS. 6A and 6B being the contrast level between the keyboard display and application display with alteration to an increased transparency of the keyboard image with emphasis to a depressed key to indicate data input;

FIG. 7 is an enlarged view of a keyboard section illustrating actuating finger input to a key with the key proximity indicator showing the proximity of the finger about to make data input; and,

FIG. 8A is a block diagram related to the start up of the keyboard this invention;

FIG. 8B is a block diagram related to the operation the software with the keyboard this invention;

FIG. 9A is a plan view of the electronically transparent keyboard with the palm sensors and IR proximity sensors for the keys; and,

FIG. 9B illustrates a digit proximate to a key on the rear side of the keyboard with the IR sensor indicating to the display to point where proximity is closest.

### DETAILED DESCRIPTION OF THE INVENTION

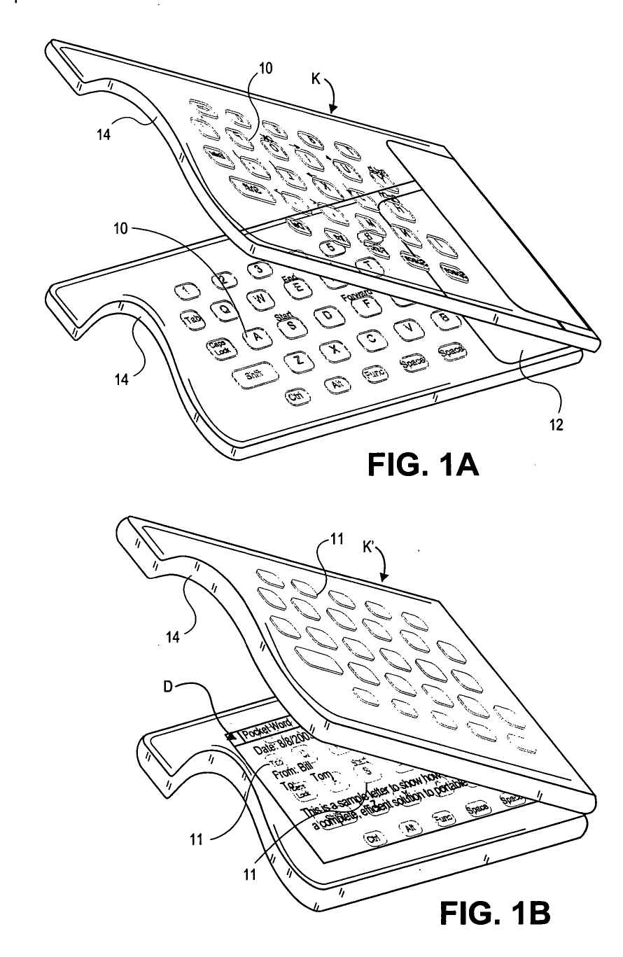

Referring to FIG. 1, the optically transparent folded keyboard of this invention is shown in a bifolded configuration. Keyboard K is of the QWERTY variety having the normal key dimension between the respective keys. As can be seen the respective keys 10 are all optically transparent; it is possible to look through one side of the keyboard and see the opposite side of the keyboard. Further, and more importantly, is possible to observe indicia identifying each of the keys from the top side of the keyboard while observing the proximity of a depressing digit of the hand on the bottom side of the keyboard.

Two features of the keyboard of FIG. 1A can be noted. First, side indentations 14 are placed on opposite edges of keyboard K. These indentations 14 make possible the support of the keyboard K at the palms of the hand while the digits of the hand imprint to the reverse side of the illustrated keys 10.

Second, keyboard K defines a central support area 12 for supporting an electronic device. It will be understood that the electronic device can be a cellular telephone, a personal digital assistant (PDA), or virtually any handheld computing device.

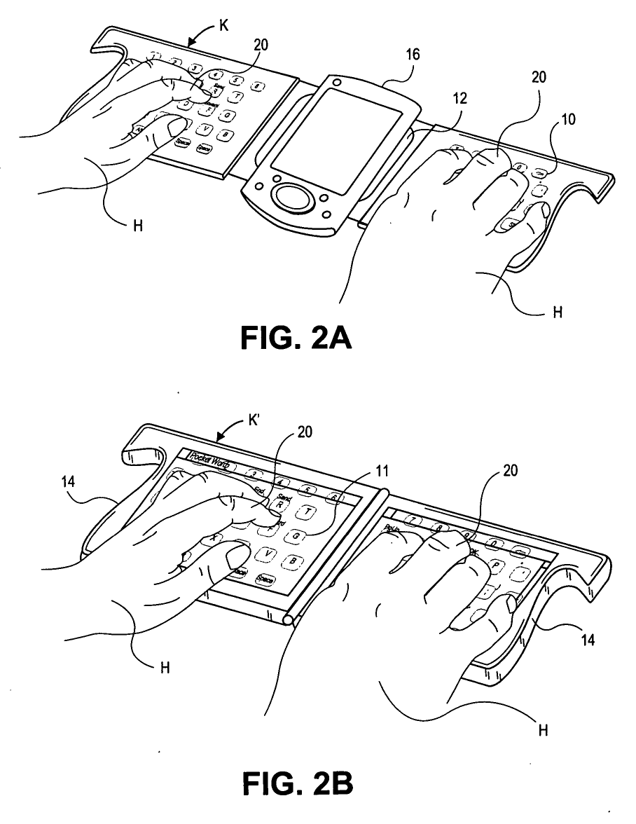

Referring to FIG. 2A, PDA 16 has been placed on central support area 12 in the landscape mode. Apparatus for communication between keyboard K and PDA 16 is not shown but it will be understood that direct connection, IR (infrared) connection, or such communication protocols as Blue Tooth (trademark) can be used. As these connections are all known and understood, they will not be further hereinafter set forth. Hands H with digits 20 are shown conventionally inputting data.

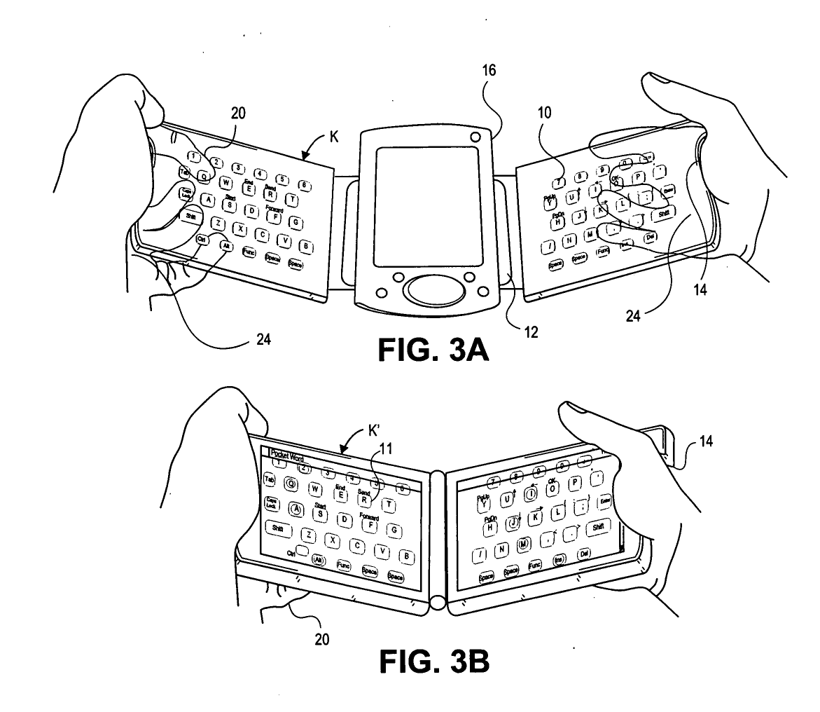

Referring to FIG. 3A, PDA 16 is shown vertically oriented on central support area 12 while keyboard K is supported at indentations 14 between the palms 24 of a user. With this support, it will be noted that the keyboard and PDA can be supported while the digits 20 access the reverse side of the keyboard. View of the digits 20 is directly through the transparent keyboard K with the input of keyboard data being from the reverse and or backside of keyboard K. It will be noted that indentations 14 conformed the keyboard K to the palms materially assisting in keyboard K support with PDA 16 likewise being supported.

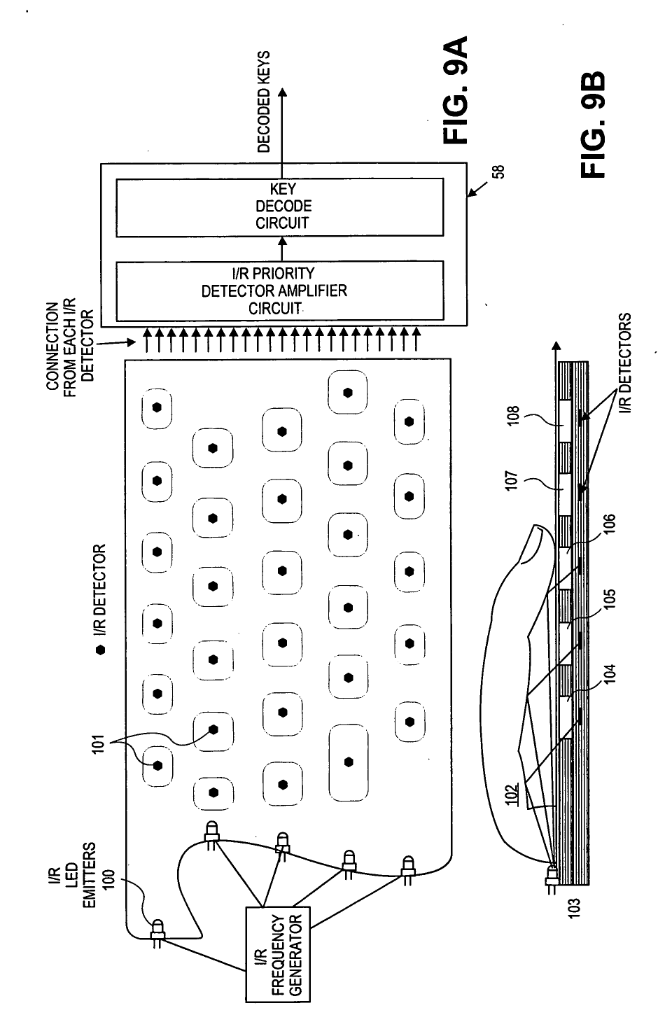

The embodiments of FIGS. 1B, 2B and 3B will now be described. Referring to FIG. 1B, keyboard K′ is shown having a miniaturized appliance embedded within the keyboard. The keyboard is equipped with a touch screen so that three functions are represented. First, the display D of the computer is on the keyboard K′. Second, the individual keys 11 are superimposed upon the display D of the keyboard K′. Third, it will be seen that the keys 11 on the reverse side of the keyboard are not labeled; instead as will hereafter be set forth with respect to FIG. 9B, the proximity of the digits 20 of the user to the keys will be electronically relayed to the user by the display D, rendering the keyboard K′ “electronically” transparent the reader will understand that the labeling of the keys on the opposite side of keyboard K′ is optional; labeling could occur if it is desired.

Referring to FIG. 2B, conventional operation of keyboard K′ is illustrated. Digits 20 of the user are incident upon the display D. Thus the surface of the display D has two functions; first to act as a keyboard and second to display the output of the program.

Referring to FIG. 2, use of the keyboard K′ is shown in a normal mode. Digits 20 of the user are shown typing of display D, which display D is at the same time displaying the operation of the program.

Finally, with respect to FIG. 3B, use of the keyboard K′ in the “electronically transparent mode is shown. Keyboard K” is shown braced by the palms of the user at indentations 14 with digits 20 of the user operating keys on the reverse side of the keyboard K′. It will be understood that this operation of keyboard K′ has the advantage of presenting the user with an unobstructed view of the display D.

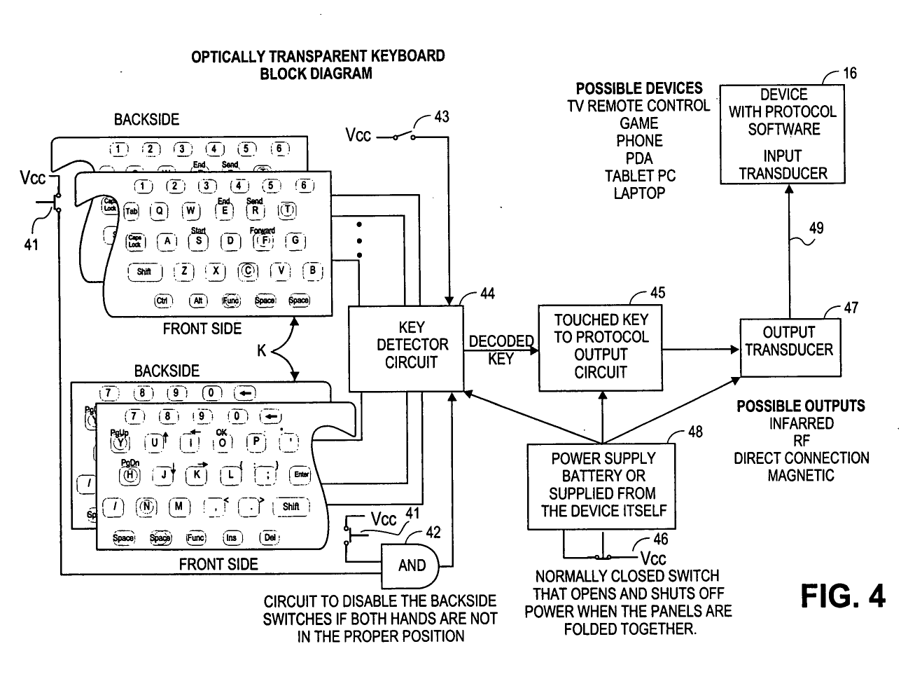

Circuitry activating the keyboard is for the most part conventional. Referring to FIG. 4, sensors 41 and 42 are placed at the respective indentations 14 on opposite sides of keyboard K. And gate 42 is closed upon depression of both sensors and enables key detector circuit 44 to receive keyboard depression from the reverse side of the keyboard K. In the preferred embodiment without AND gate 42 being closed, input data from the reverse side of the keyboard will not be received. Power supply 48 can either be from a battery within the keyboard itself or from the device's power, such as a directly connected PDA 16. Switch 46 is preferred and shuts off power to the keyboard once it is folded to the closed position. Input from key detector circuit 44 passes through output circuit 45 to output transducer 47. Output transducer 47 outputs at 49 to device 16. As before, output can include direct connection, IR connection, or alternatively protocols such as Blue Tooth (trademark). Additionally, switch 43 can be used to activate front side keyboard entry, although this is not required.

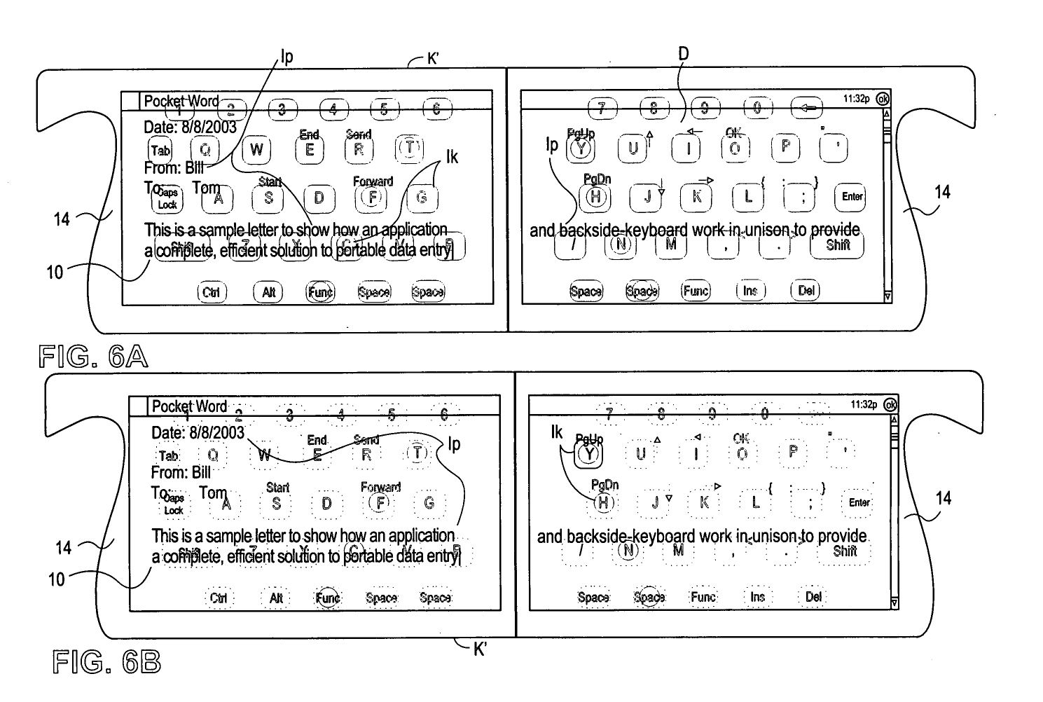

Referring to FIGS. 6A and 6B, a bifolded keyboard K′ is shown having a device 16 that is embedded and therefore not visibly separate from the keyboard of this invention. The keyboard itself serves both as the display for an application program 10, here is shown as a word-processing program at image Ip, and additionally provides on the front surface of the keyboard K′ a superimposed image Ik. Again, keyboard K′ permits input from the reverse side in a manner precisely analogous to the keyboard K illustrated with respect to FIGS. 1A, 2A, and 3A. As before, indentations 14 are present on both sides of keyboard K′.

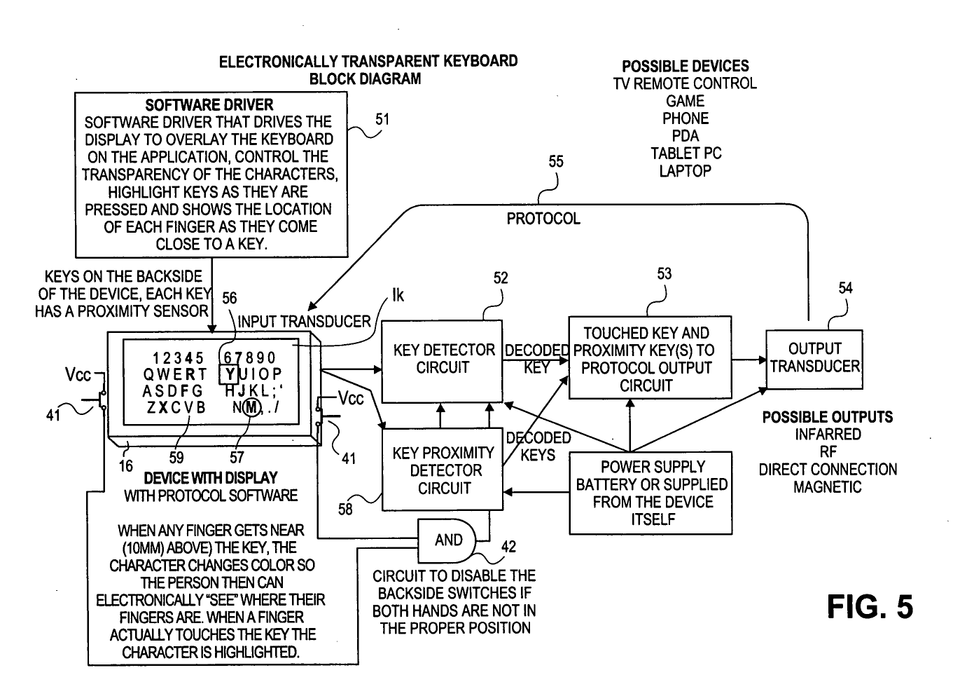

Due to the fact that a display D (which is a touch sensitive screen) has two superimposed images is placed upon it, it will be understood that the keyboard K′ is not transparent. However, it will further be understood that keyboard K′ has a reverse side which is precisely analogous to that illustrated with respect to FIGS. 1B, 2B, and 3B. Since the keyboard is not optically transparent, it is necessary that the image Ik render the keyboard K′ “electronically transparent.” This principle can be understood with respect to FIG. 5.

Referring to FIG. 5, the reader will understand that for simplicity we do not show application program image Ip; we show only keyboard image Ik (although in reality both will be present). Referring to FIG. 5, software driver 51 in enables image Ik to overlie application program image Ip. Additionally, and a shown in FIGS. 6A and 6B, the intensity of keyboard image Ik relative to application program image Ip can be regulated. For example, where a new user of the keyboard might with to concentrate more on the placement of the keyboard image and less on the image of the application program, as in the word-processing program here illustrated, the image Ik of the keyboard can predominate over the application program image Ip. Alternatively, in the case of an experienced user, the image Ik of the keyboard can be suppressed with the image Ip of the application program predominating. This contrast in images is done with a standard software interface.

Continuing on with FIG. 5, sensors 41 enable AND gate 42 to enable the reverse keyboard K′. Three discrete indicia are shown in keyboard image Ik. First, actual depression of a key is here shown by indicating in the emphasized font in an area about the actual key depression for the input of data. Here the selected key 56 is “Y”. Actual key depression goes to detector circuit 52 through output circuit 53 output transducer 54 typically back through protocol line 55 into the device 16 which is here are understood to be integral with the illustrated keyboard.

Second, it may be necessary to indicate the proximity of a depressing digit on the reverse side the keyboard so the tactilely inexperienced user can know the proximity of his digit to a particular key to be depressed. In this embodiment, keyboard image Ik is given different indicia such as that illustrated at “M” 57 that a digit is proximate the “M” key on the reverse side of the keyboard. Such proximity passes through proximity key detector 58.

Third, and in order to show the available keys, keyboard image Ik includes indicia 59 illustrating the undepressed keys not having a digit in their proximity.

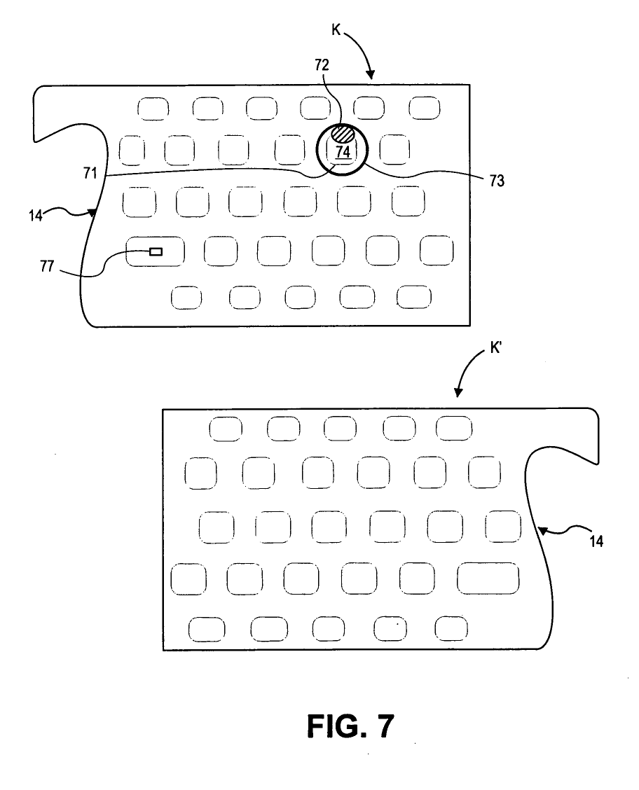

Fix Paragraph Referring to FIG. 7, the touch sensitivity of keyboard K′ can be illustrated. The keyboard bezel 71 is illustrated juxtaposed to an area of digit closing contact 72 an area of the limiter 73 is drawn about the particular key 74 in question. Simply stated, a digit having an area of contact such as that illustrated at 72 inside of limiter 73 will cause either input or proximity sensing as hereinbefore described. It will be understood that the respective keys on the reverse side of the keyboard can be provided with individual miniaturized infrared sensors 77 (here only shown superimposed on a single shift key). While it is not preferred, miniature cameras could as well be used.

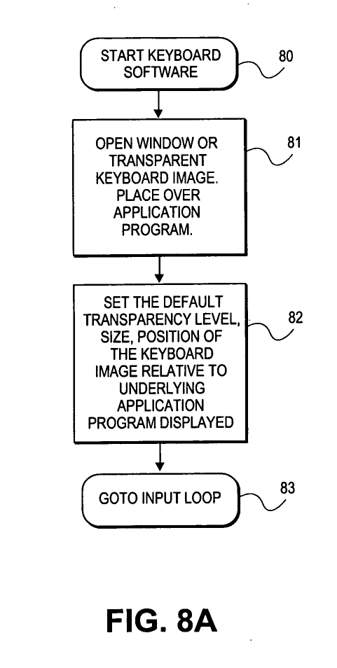

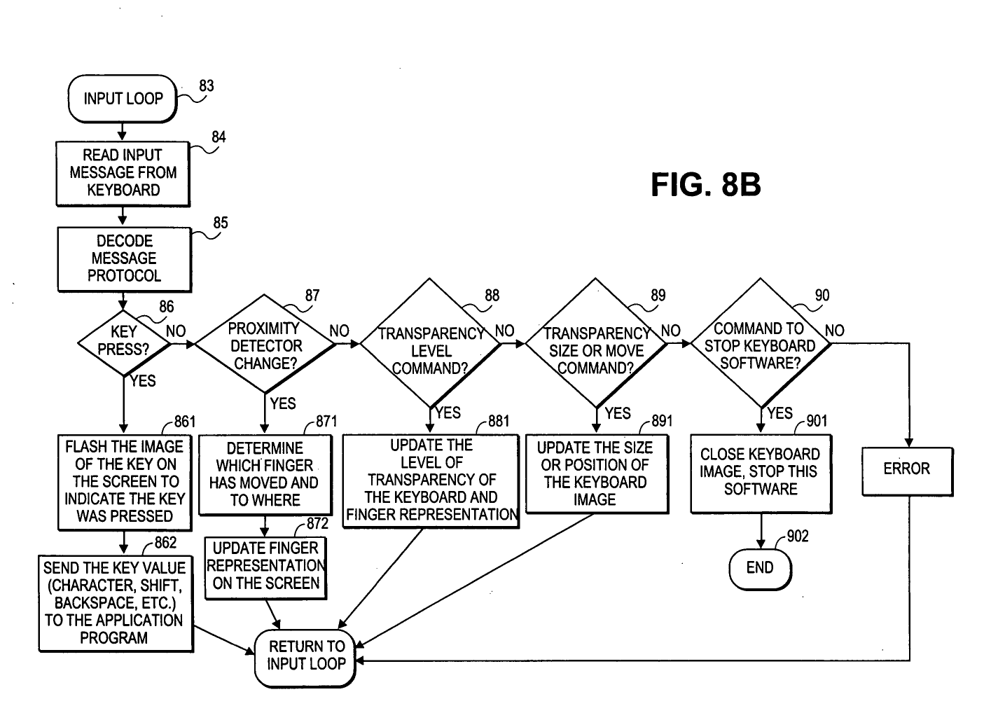

Referring to FIG. 8A, the keyboard software is started at 80. In step 81, a window of the transparent keyboard image is opened and placed over the application program. It step 82, the default transparency level as well as the size, and position of the keyboard image relative to the underlying application is set in a default mode. Thereafter, the program goes to the input loop 83.

Referring to FIG. 8B, input loop 83 is shown with an input message being read from the keyboard at 84. The message is decoded at 85 and thereafter routed to conditional branches 86, 87, 88, 89, and 90. Presuming that an alphanumeric key is pressed at conditional branch 86, an image on the screen is emphasized (as by a flash) at 861 and key value forwarded to the application program at 862. Presuming that a key is not pressed at conditional branch 86, proximity detector conditional branch 87 determines which key a digit is proximal to at 871 and makes the appropriate representation at 872. Presuming no proximity detector actuation, a transparency level command is looked for with updating of the transparency level at 881. Further, if a size or move command is received updating of the size or position of the keyboard image occurs at 891. Such sizing or moving can occur with a standard software interface. Finally if there is a command to stop the keyboard software at conditional branch 90, the keyboard image is shutdown and the software taken off line at 901. The keyboard program is shutdown at 902. As of this writing, software performing the above function has been written and is functional.

FIG. 9A illustrates a reverse side of an electronically transparent keyboard with IR emitters and sensors for indicating the proximity of the digits to the keys. Specifically, palm IR emitters 100 are shown for detecting the motion of the fingers. Ir sensors 101 are shown at each key for detecting digit proximity through reflection of Ir radiation from the emitters.

FIG. 9B illustrates a digit 102 extending from palm 103 over keys 104, 105, 106. The IR sensor 101 at key 106 will sense the closest proximity of digit 102 and through the circuitry illustrated in FIG. 5 cause differentiation of the image of key 106 at the display. Keys 104, 105, 107 and 108 will not have their corresponding indicia at the display activated.

1. A keyboard having keys for receiving input comprising:
a plurality of keys for receiving input from either side of the keyboard;
a peripheral support for enabling keyboard support between the hands of a user to receive input at the keys from the digits of the user; and,
a transparent portion of the keyboard enabling view from the top of the keyboard to the digits of the user at the bottom of the keyboard during the input.

2. The keyboard having keys for receiving input according to claim 1 and wherein:
the peripheral support for enabling keyboard support between the hands of a user to receive input at the keys from the digit of the user includes peripheral sensors for detecting the hands supporting the keyboard; and
a circuit interconnected between the sensors and the keyboard for activating the keys on the rear side of the keyboard.

3. The keyboard having keys for receiving input according to claim 1 and wherein:
a key for activating the front side the keyboard only whereby digital input of the keyboard is restricted to the keyboard at the front side when the key for activating is depressed.

4. A keyboard having keys for receiving input comprising:
a plurality of keys for receiving input from either side of the keyboard;
a peripheral support for enabling keyboard support between the hands of a user to receive input at the keys from the digits of the user;
an electronic device communicating with the keyboard;
a display interactive with the electronic device including input from the keyboard;
an application program accepting input from the keyboard and having output to the display to indicate function of the application program;
an image of the keyboard superimposed upon the application program including individual keys on the display side of the keyboard.

5. The keyboard having keys for receiving input according to claim 4 and wherein:
an interface for varying the transparency of the image of the keyboard relative to the application program.

6. The keyboard having keys for receiving input according to claim 4 and wherein:
the image of the keyboard superimposed upon the application program includes differentiating the image of individual keys from the remaining keys to indicate proximity of a digit to a key.

7. The keyboard having keys for receiving input according to claim 4 and wherein:
the differentiating of the individual key includes differentiating of the key to indicate data input.

8. The keyboard having keys for receiving input according to claim 6 and wherein:
the differentiating of the individual key includes differentiating of the key to indicate digital proximity to the key.

9. The keyboard having keys for receiving input according to claim 6 and wherein:
means for superimposing on the image of the keyboard indicia indicating proximity of a digit to the key includes a sensor located proximate the key.

10. The keyboard having keys for receiving input according to claim 1 and wherein:
the electronic device is attached to the keyboard.

11. The keyboard having keys for receiving input according to claim 4 and wherein:
the electronic device is integral to the keyboard.

12. The keyboard having keys for receiving input according to claim 1 and wherein:
the keyboard includes indentations at the sides thereof for receiving support for the keyboard from the hands of a user.

13. The keyboard having keys for receiving input according to claim 4 and wherein:
the keyboard includes indentations at the sides thereof for receiving support for the keyboard from the hands of a user.

14. The keyboard having keys for receiving input according to claim 1 and wherein:
the keyboard has connections for connections to an electronic device, the connections chosen from the group consisting of direct electrical connections, infrared, and Blue tooth.

15. The keyboard having keys for receiving input according to claim 4 and wherein:
means for moving the image of the keyboard relative to the display indicating function of the application program.

16. The keyboard having keys for receiving input according to claim 1 and wherein:
the plurality of keys for receiving input from either side of the keyboard includes a first keyboard half and a second keyboard half; and
a central hinge enabling the first keyboard half to fold overlying the second keyboard half.

17. The keyboard having keys for receiving input according to claim 4 and wherein:
the plurality of keys for receiving input from either side of the keyboard includes a first keyboard half and a second keyboard half; and
a central hinge enabling the first keyboard half to fold overlying the second keyboard half.

18. The keyboard having keys for receiving input according to claim 1 further including:
the plurality of keys for receiving input from either side of the keyboard includes a first keyboard half and a second keyboard half; and
a central support and display area for electronic appliances is placed between the first keyboard half hand the second keyboard half.

19. A process for input through a keyboard comprising the steps of:
providing a keyboard having a plurality of keys for receiving input from either side of a keyboard;
providing a peripheral support to enable keyboard support between the hands of a user to receive input at the keys from the digits of the user;
supporting the keyboard between the hands of a user with the digits extending to an underside of the keyboard; and,
providing a transparent keyboard to enabling view of the keyboard during the input from either side of the keyboard; and,
inputting data to the keyboard with the digits of the user and viewing the digits of the user at the transparent keyboard.

20. The process for input through a keyboard according to claim 19 the providing of the transparent keyboard includes the further steps of:
inputting data to the front of the keyboard.

21. The process for input through a keyboard according to claim 19 wherein this step of providing a plurality of keys includes:
providing a plurality of transparent keys; and,
imprinting indicia on the transparent keys for enabling identification of the input of the keys from either side of the keyboard.

22. The process for input through a keyboard of claim 19 wherein this step of providing a plurality of keys includes:
providing peripheral support about the plurality of keys for receiving input from either side of the keyboard; and,
placing palm sensors at the peripheral support; and,
activating the keyboard upon the sensors being contacted at the sides of the keyboard.

23. The process for input through a keyboard of claim 19 and wherein the inputting of data to the keyboard includes;
detecting the support of the keyboard between the hands of the user; and,
enabling the plurality of keys for receiving input from back side of the keyboard to receive input from the underside of the keyboard when support of the keyboard between the hands of the user is detected.

24. A process for input through a keyboard comprising the steps of:
providing a plurality of keys for receiving input from either side of a keyboard;
providing a peripheral support to enable keyboard support between the hands of a user to receive input at the keys from the digits of the user;
supporting the keyboard between the hands of a user with the digits extending to an underside of the keyboard;
providing an image of the keyboard on the display having a view from the top of the keyboard during the input, and,
inputting data to the keyboard with the digits of the user while holding the keyboard and viewing the display.

25. The process for input through a keyboard according to claim 24 and including the further steps of:
providing an image of the keyboard includes providing indicia indicating input of data at a key.

26. The process for input through a keyboard according to claim 25 and including the further steps of:
providing an image of the keyboard includes providing indicia indicating the proximity of a digit at a key.

27. The process for input through a keyboard according to claim 24 and including the further steps of:
providing an electronic device having a display that receives input from the keyboard and has output indicating the function of an application program running in the electronic device; and,
superimposing an image of the keyboard overlying the output indicating the function of the application program.

28. The process for input through a keyboard according to claim 24 and including the further steps of:
providing the display on an electronic device.

29. The process for input through a keyboard according to claim 27 and including the further steps of:
providing the display integral to the keyboard.

30. The process for input through a keyboard according to claim 24 and wherein the provided display of the keyboard having a view from the top of the keyboard to the digits of the user and includes:
providing a first display at the keyboard having a view from the top of the keyboard to indicate the proximity of the digits of the user to the keys; and,
providing a second display at the keyboard having a view from the top of the keyboard to indicate the contact at the digits of the user to the keys for input.
